(19) United States
(12) Patent Application Publication
(10) Pub. No.: US 2021/0094701 A1
(43) Pub. Date: Apr. 1, 2021

(54) METHOD FOR DATA TRANSMISSION, DATA CARRIER UNIT, BATTERY SYSTEM AND AIRCRAFT HAVING A DATA CARRIER UNIT

(71) Applicant: Volocopter GmbH, Bruchsal (DE)

(72) Inventor: Christopher WINKLER, Germersheim (DE)

(73) Assignee: Volocopter GmbH, Bruchsal (DE)

(21) Appl. No.: 17/004,439

(22) Filed: Aug. 27, 2020

(30) Foreign Application Priority Data
Sep. 30, 2019 (DE) 102019126260.7

(51) Int. Cl. B64D 45/00; B60L 53/80; B64D 27/24; B64C 29/00; H04L 29/08

(52) U.S. Cl. CPC B64D 45/00; B60L 53/80; B64D 27/24; B64D 2045/0085; H04L 67/12; B60L 2200/10; B64C 29/00

(57) ABSTRACT

A method for transmitting data between an electric aircraft and a ground station by a data carrier unit, which involves data to be conveyed from the aircraft being stored in the data carrier unit, a connection being made between the data carrier unit and a computing unit of the ground station, and the data to be conveyed being transmitted via the connection. A fundamental aspect is that the data carrier unit is integrated in a battery system of the aircraft and the connection for transmitting the data is made to the computing unit of the ground station when the battery system is replaced. The invention also relates to a data carrier unit, a battery system and an aircraft.

### INCORPORATION BY REFERENCE

The following documents are incorporated herein by reference as if fully set forth: German Patent Application No. 10 2019 126 260.7, filed Sep. 30, 2019.

### TECHNICAL FIELD

The present invention relates to a method for transmitting data between an electric aircraft and a ground station, a battery system for an aircraft, a data carrier unit, and a vertical takeoff and landing aircraft.

### BACKGROUND

Vertical takeoff and landing aircraft, also known as VTOL, are used both for transporting people, autonomously or under the control of a pilot flying with them, and for transporting loads, by remote control or autonomously. Vertical takeoff and landing aircraft having multiple rotors are known, in particular from DE 10 2012 202 698 A1.

In the course of operation, large volumes of data need to be transmitted between the aircraft and a ground station during and/or after a flight, such as for example flight log data, software updates, multimedia data for the in-flight entertainment and much more. These volumes of data need to be transmitted within short periods of time. At present, this is accomplished by radio transmission or by data carriers. Radio transmission requires technical systems for the radio transmission both in the aircraft and in the ground station. These systems require installation space in the aircraft in particular. Furthermore, radio transmission systems are a gateway for malware and the like.

### SUMMARY

The present invention is therefore based on the object of proposing a method and also a data carrier unit and an aircraft that allow secure and fast transmission of large volumes of data between the aircraft and a ground station.

This object is achieved by a method, by a battery system, by a data carrier unit, and the aircraft having one or more features of the invention as described herein. Advantageous embodiments are described below and in the claims.

The method according to the invention for transmitting data between an electric aircraft and a ground station by means of a data carrier unit comprises the following steps:
A storing the data to be conveyed from the aircraft in the data carrier unit,
B making a connection between the data carrier unit and a computing unit or computer of the ground station,
C transmitting the data to be conveyed via the connection.

A fundamental aspect is that the data carrier unit is integrated in a battery system of the aircraft and the connection for transmitting the data is made to the computing unit or computer of the ground station when the battery system is replaced.

Preferably, the connection between the data carrier unit and the computing unit or controller of the aircraft is made when the battery system is connected to the aircraft. The connection between the data carrier unit and the computing unit of the aircraft is made in the form of a physical connection.

The invention is based on the insight of the applicant that the regular replacement of the battery system (battery swap) can be used for transmitting data by virtue of the data carrier unit being integrated in the replaceable battery system. During flight, large volumes of data, e.g. flight log data, route information, aircraft data, surroundings data or the like, can be stored on the data carrier unit. After the aircraft lands, the battery system with the data carrier unit is replaced. In the ground unit, the data carrier unit is connected to a computer and thus the data are transmitted via a physical connection.

It is likewise part of the invention that data, such as for example software updates, entertainment data, customer-specific data, route information or the like, are transmitted from the ground unit to the data carrier unit of the battery system. When the battery system is inserted into the aircraft, these data are transmitted from the data carrier unit to the computing unit of the aircraft.

“Replacing the battery system”, within the context of this description, can also cover inserting the battery system into the aircraft, regardless of when and whether the previous battery system was removed. The same also applies to removal of the battery system without a subsequent battery system being inserted immediately thereafter.

The data transmission purely via physical connections, for example in the form of a cable connection or a direct connection, means that it is difficult or scarcely possible to smuggle (alien) malware or the like into a network of the aircraft. This significantly increases flight safety and fail-safety.

In a preferred development of the method according to the invention, data are transmitted from the data carrier unit to the computing unit of the aircraft. Preferably, a bidirectional data transfer takes place from the data carrier unit to the computing unit of the aircraft and from the computing unit of the aircraft to the data carrier unit. This bidirectional data transfer does not have to take place in both transmission directions at the same time, but rather can be effected at different times, namely for example from the aircraft to the data carrier unit during flight and from the data carrier unit to the aircraft when the battery system with the data carrier unit is inserted.

Preferably, every replacement of the battery system results in an automated transmission of the data being effected. Preferably, an automated evaluation of the data stored on the data carrier unit is effected after the transmission. Any abnormalities arising can therefore be detected as quickly as possible and problems can be forecast. For example, vibration data for the support structure of the aircraft or for specific structural parts can be captured and recorded. These vibration data can be evaluated with respect to limit values or differences and can provide indications of damage arising on the structural parts. This allows action to be taken as a preventive measure already or at an early time, and maintenance measures to be initiated.

In a preferred development of the method according to the invention, there is traceability and flight history for the data carrier unit. Statutory provisions and general security requirements mean that high requirements are imposed on the traceability and consistency of the flight history. Preferably, a replacement of the battery system results in explicitly assignable information about the combination of aircraft, battery system and data carrier unit being stored, so as also to be able to assign a data carrier unit to an aircraft and the completed flight subsequently. Preferably, this information is stored in the computing unit of the ground station.

Preferably, the computing unit of the aircraft is integrated by means of the data carrier unit in an overall operating system and/or a network that networks subscribers, that is to say aircraft, ground stations, battery systems, data carrier units, etc., of the overall system. Based on the networking of the overall system there is the possibility of customer-specific and prompt planning, preparation and making-available of a charged battery system with a prepared data carrier unit. The applicable data carrier unit already stores the data intended for transmission, such as for example customer-specific data, a flight plan or weather data. When the battery system is connected to the aircraft, these data are transmitted as already described and can be used by the computing unit of the aircraft.

The present object is also achieved by a battery system for an aircraft having one or more features described herein.

The battery system for an aircraft according to the invention is suitable for a vertical takeoff and landing electric aircraft in particular.

A fundamental aspect is that the battery system comprises a data carrier for storing and/or transmitting data of the aircraft.

The battery system according to the invention likewise has the aforementioned advantages of the described method according to the invention and/or of the described preferred embodiments of the method according to the invention.

The integration of the data carrier in the battery system allows simple and efficient transfer of large volumes of data via a physical connection when the battery system is replaced.

Electric vertical takeoff and landing aircraft are typically driven by electric motors, which are battery powered. To this end, the aircraft have a battery system, normally comprising multiple batteries, which can be charged as part of the aircraft or is replaceable. The advantage of a replaceable battery system is that long charging periods for the batteries can take place outside the aircraft. When an aircraft approaches a ground station, fully charged battery systems can be made available, which can be exchanged for a partially or completely discharged battery system of the aircraft. This allows longer flying distances to be covered with short intermediate stops without long charging periods.

In a preferred embodiment of the battery system, the data carrier unit has at least one interface to a computing unit of the aircraft, preferably to a communication network of the computing unit of the aircraft. Particularly preferably, the interface is in the form of a data bus or a multimedia bus. This advantageously allows fast and simple transmission of the data via a secure physical connection. Preferably, the data carrier unit additionally has at least one interface to a computing unit of the ground station.

The object according to the invention is also achieved by a data carrier unit with one or more features described herein.

The data carrier unit for storing and/or transmitting flight data of an aircraft is part, according to the invention, of a replaceable battery system of the aircraft.

The data carrier unit according to the invention likewise has the aforementioned advantages of the described methods according to the invention and/or preferred embodiments of the method according to the invention and of the described battery system according to the invention.

The integration of the data carrier unit in the replaceable battery system of the aircraft uses the regular replacement of the battery system to transmit large volumes of data from the aircraft and/or to the aircraft with a physical data connection in an efficient and regularly occurring process.

In a preferred development of the invention, the data carrier unit has at least one interface to a computing unit of the aircraft, in particular to a communication network of the computing unit of the aircraft, preferably in the form of a data bus and/or a multimedia bus. This advantageously allows fast and simple transmission of the data via a secure physical connection. Preferably, the data carrier unit additionally has at least one interface to a computing unit of the ground station. This allows fast and secure transmission of the data via a comparatively secure physical connection.

In a preferred embodiment of the invention, the data carrier unit is in the form of an association of multiple data carriers. Depending on the criticality of the data to be transmitted, different demands can be made on the hardware and/or software, the transmission medium, the protocol, etc.

For example, high security requirements are not normally imposed on the medium for the transmission of customer-specific data, such as video streaming. It is therefore possible to use comparatively simple and inexpensive data carriers such as an SSD hard disk.

On the other hand, stable data carriers, preferably with a redundant storage system (RAID), can be used for critical data such as flight logs, firmware, etc., and in particular for data for which it is necessary to meet an obligation to provide evidence (for example black box data).

This advantageously allows critical and noncritical data transmissions to be performed in a physically separate manner and both as securely as possible and as efficiently and inexpensively as possible.

Preferably, the data carrier unit having one or more data carriers meets the necessary security requirements for the data that are to be stored for each of the data carriers (storage media). In particular for critical data, high security requirements need to be met in this case by virtue of the data being transmitted by robust hardware and a suitable interface, for example, in order to ensure that specific error tolerances are not exceeded during the data transmission in flight. These error tolerances are specified by the security class of the data to be transmitted, for example by the operator or by the competent authority.

The data carrier unit and/or the data carriers (storage medium) are preferably in the form of an SSD (solid state disk), SD card and/or USB stick or in the form of a combination of the aforementioned storage media.

The object according to the invention is also achieved by a vertical takeoff and landing aircraft having a replaceable battery system and a data carrier unit for storing and/or transmitting data from and/or to a computing unit of the aircraft.

A fundamental aspect is that the data carrier unit is part of a replaceable battery system.

Preferably, the battery system is configured according to the invention as a replaceable battery system as described. More particularly preferably, the data carrier unit is configured according to the invention as described.

The vertical takeoff and landing aircraft likewise has the aforementioned advantages of the method according to the invention and/or of an embodiment of the method according to the invention and also of the battery system according to the invention and of the data carrier unit according to the invention.

Preferably, the computing unit of the aircraft is part of an overall operating system and/or a network that networks subscribers, that is to say aircraft, ground stations, battery systems, data carrier units, etc., of an overall system. Based on the networking of the overall system there is the possibility of customer-specific and prompt planning, preparation and making-available of a charged battery system with a prepared data carrier unit. The applicable data carrier unit already stores the data intended for transmission, such as customer-specific data, a flight plan or weather data. When the battery system is connected to the aircraft, these data are transmitted as already described and can be used by the computing unit of the aircraft.

### BRIEF DESCRIPTION OF THE DRAWINGS

Further preferred features and embodiments of the method according to the invention and of the battery system according to the invention and also of the data carrier unit according to the invention and of the aircraft according to the invention are explained below on the basis of exemplary embodiments and the figures. The exemplary embodiments and the indicated measurements are merely advantageous configurations of the invention and are not limiting.

In the figures:

FIG. 1 shows a schematic depiction of an exemplary embodiment of an aircraft according to the invention, and

FIG. 2 shows a flowchart for an exemplary embodiment of the method according to the invention.

### DETAILED DESCRIPTION

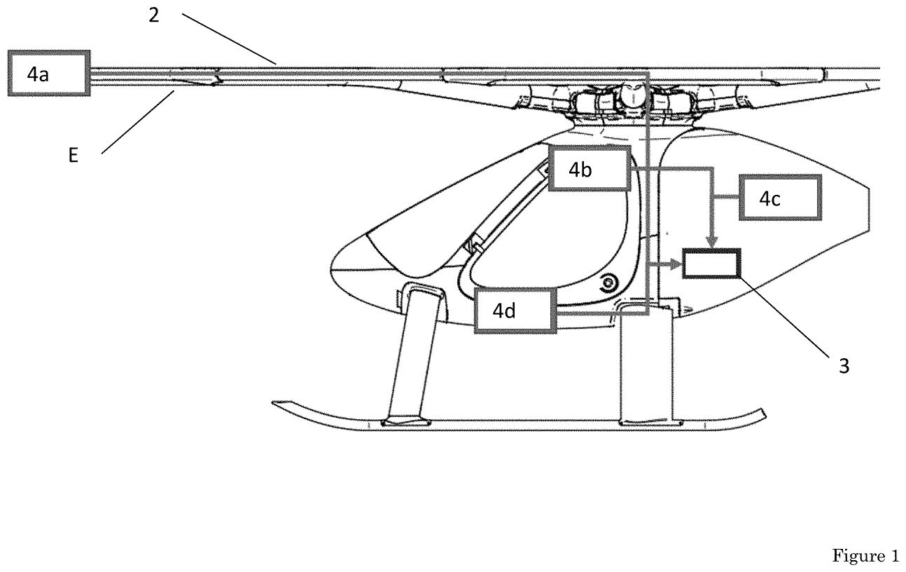

FIG. 1 shows a vertical takeoff and landing electronic aircraft 1, also referred to as aircraft or multicopter hereinbelow. Such an aircraft 1 may be an aircraft from the brand Volocopter® from the applicant's company, for example and without restriction.

The aircraft has multiple motor/rotor combinations, in the present case motor/rotor combinations that are arranged in a common rotor plane E.

The electric motors of the motor/rotor combinations 2 are powered by batteries. The batteries are arranged in a battery system 3. In the present case the battery system 3 comprises multiple batteries.

The battery system 3 also comprises a data carrier unit for storing and transmitting data of the aircraft.

The data carrier unit in the present case is in the form of an association of data carriers having multiple suitable physical interfaces. The data carriers are in the form of an SSD (solid state disk).

The data transmission can be effected via a multimedia bus or via a data output of a bus subscriber that converts the bus data and sends them to the data carrier unit. The bus subscriber may optionally be integrated in the replaceable battery system 3. There is provision for a physical connection from the bus subscriber to the data carrier unit. Further, the data carrier unit has an interface to a computing unit of a ground station.

In FIG. 1, the reference signs 4a, 4b, 4c, 4d denote possible destinations or sources for data that are to be conveyed. Data such as flight data, performance of the aircraft and of individual components, power consumption, data interchange, temperature evolution, wind speed, humidity, air pressure, ambient temperature are recorded at the rotors and central computing units of the aircraft and by means of the onboard sensor system. Similarly, data such as software updates, multimedia data, flight plans, weather data can be stored and processed in the central computing units of the aircraft, for example.

The aircraft is part of a network that networks subscribers, that is to say aircraft, ground stations, battery systems, data carrier units, etc., of an overall system. Based on the networking of the overall system, there is the possibility of customer-specific and prompt planning, processing and need-based making-available of a charged battery system with a prepared data carrier unit for use in the aircraft.

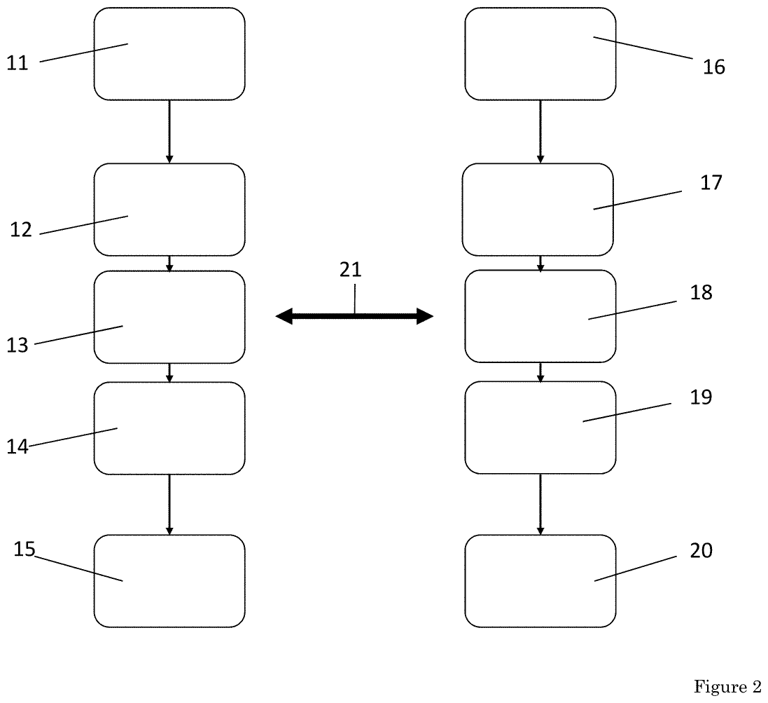

The sequence is described in detail with reference to FIG. 2.

FIG. 2 shows a flowchart for an exemplary embodiment of the method according to the invention.

The method for transmitting data between an electric aircraft and a ground station is based on a data carrier unit. The data carrier unit is part of a battery system and can be physically connected to a computing unit of the aircraft and to a computing unit of the ground station.

During flight, data such as flight data, performance of the aircraft and of individual components, power consumption, data interchange, temperature evolution, wind speed, humidity, air pressure, ambient temperature, etc., are obtained and made available to the network or control units, etc. A measured value is converted into a signal that can be sent via a data line, e.g. bus, characterized by the method step with the reference sign 11.

The data are stored on the data carrier unit I of the battery system I, characterized by the method step with the reference sign 12.

At the same time, a battery system II is charged at a ground station, characterized by the method step with the reference sign 16. The data carrier unit II of the battery system II is used to store data, such as software updates, multimedia data, flight plans, weather data, etc., for transmission to the aircraft, characterized by the method step with the reference sign 17.

The data carrier unit II therefore stores the data intended for transmission, such as customer-specific data, a flight plan or weather data.

When the aircraft lands or makes an intermediate stop, the battery system is replaced (battery swap), characterized by the double-headed arrow with the reference sign 21: the battery system I is removed from the aircraft, characterized by the reference sign 13, and connected to the computing unit of the ground station. The battery system II is inserted into the aircraft and connected to the aircraft, characterized by the method step with the reference sign 18.

In a next step, the data stored on the data carrier unit II of the battery system II are transmitted to the computing unit of the aircraft, characterized by the reference sign 14.

In the ground unit, the data are transmitted from the data carrier unit I of the battery system I to the computing unit of the ground unit and automatically evaluated, characterized by the method step with the reference sign 19.

The automated evaluation allows abnormalities that arise to be detected as quickly as possible and problems to be forecast. For example, vibration data for the support structure of the aircraft or for specific structural parts can be captured and stored on the data carrier I. These vibration data can be evaluated in the ground station with respect to limit values or differences and can provide indications of damage arising on the structural parts. This allows action to be taken as a preventive measure already or at an early time, and maintenance measures to be initiated.

Subsequently, the battery system I can be recharged and reused, characterized by the method step with the reference sign 20. For the next use, customer-specific data, software updates, etc., are stored individually on the data carrier I for the next flight.

During flight, further flight data can be recorded, as described, and stored on the data carrier unit II now of the battery system II and processed further as described, characterized by the method step with the reference sign 15.

1. A method for transmitting data between an electric aircraft (1) and a ground station using a data carrier unit, comprising:
A storing data to be conveyed from the aircraft (1) in the data carrier unit;
B making a connection between the data carrier unit and a computing unit of the ground station; and
C transmitting the data to be conveyed via the connection;
wherein the data carrier unit is integrated in a battery system of the aircraft (1) and the connection for transmitting the data is made to the computing unit of the ground station during replacement of the battery system (3).

2. The method as claimed in claim 1,
wherein the connection between the data carrier unit and a computing unit of the aircraft (1) is made when the battery system (3) is connected to the aircraft (1).

3. The method as claimed in claim 2,
wherein the connection between the data carrier unit and the computing unit of the aircraft (1) is a physical connection.

4. The method as claimed claim 2,
wherein the data are transmitted from the data carrier unit to the computing unit of the aircraft (1).

5. The method as claimed in claim 4,
wherein a bidirectional data transfer takes place from the data carrier unit to the computing unit of the aircraft (1) and from the computing unit of the aircraft (1) to the data carrier unit.

6. The method as claimed in claim 1,
wherein every replacement of the battery system (3) results in an automated transmission being effected.

7. The method as claimed in claim 6,
wherein every replacement results in an evaluation of the data stored on the data carrier unit.

8. The method as claimed in claim 1,
further comprising providing traceability and flight history for the data carrier unit.

9. The method as claimed in claim 8,
wherein the computing unit of the ground station stores explicit information about a combination of aircraft (1), the battery system and the data carrier unit when the battery system (3) is replaced.

10. A battery system for an aircraft, comprising
a battery, and
a data carrier unit for at least one of storing or transmitting data of the aircraft (1).

11. The battery system as claimed in claim 10,
wherein the battery system (3) is replaceable.

12. The battery system as claimed in claim 10,
wherein the data carrier unit has at least one interface for a computing unit of the aircraft (1).

13. The battery system as claimed in claim 12,
wherein the data carrier unit has at least one interface for a communication network of the computing unit of the aircraft in the form of at least one of a data bus or a multimedia bus.

14. A data carrier unit for at least one of storing or transmitting flight data of an aircraft, comprising a memory provided as a part of a replaceable battery system (3) of the aircraft (1).

15. A vertical takeoff and landing aircraft (1), comprising:
a replaceable battery system (3) and a data carrier unit for storing and transmitting data from and to a computing unit of the aircraft (3),
and the data carrier unit is part of the replaceable battery system (3).
